(19) United States
(12) Patent Application Publication
(10) Pub. No.: US 2026/0050739 A1
(43) Pub. Date: Feb. 19, 2026

(54) Method and System for Customizing AI-Generated Character Portrayals Using Source Document Extraction

(71) Applicant: Jason Matthew Roos, Irvine, CA (US)

(72) Inventor: Jason Matthew Roos, Irvine, CA (US)

(21) Appl. No.: 18/807,001

(22) Filed: Aug. 16, 2024

(51) Int. Cl. G06F 40/284; G06F 40/295; G06F 40/40

(52) U.S. Cl. CPC G06F 40/284; G06F 40/295; G06F 40/40

(57) ABSTRACT

The invention relates to a computer-implemented method for customizing artificial intelligence-generated character portrayals. The method involves receiving a user specification of at least one source document, extracting explicit traits and narratives from the document using a natural language processing model, and validating these traits and narratives based on user input. The validated information is then integrated into a character representation module, where it is stored in association with a character profile. The method further includes generating character responses influenced by the stored traits and narratives and outputting these responses through a communicative interface. This approach allows for the creation of nuanced and contextually accurate portrayals of characters, enabling personalized interactions based on diverse source materials.

### FIELD OF INVENTION

The present invention relates generally to the field of artificial intelligence, specifically to a method for customizing AI-generated character portrayals by extracting and validating traits and narratives from various source documents.

### BACKGROUND

In the realm of artificial intelligence (AI), the accurate and nuanced portrayal of historical figures, fictional characters, or other personas remains a challenge. Current AI systems often rely on generalized training data, leading to interpretations that lack depth and fail to respect the diversity of expert perspectives. These systems typically generate outputs based on broad, non-specific prompts, which can result in inconsistent and superficial representations.

One issue with existing models is their reliance on a fixed corpus of data, which may not encompass the wide range of scholarly interpretations or lesser-known aspects of a figure's life and identity. This can lead to portrayals that are both stereotypical and lacking in detail, failing to capture the complexity of the character being emulated. Furthermore, while current systems allow users to input prompts that can provide some level of interpretive guidance, they lack a robust support structure to ensure that this guidance leads to consistent and accurate outputs.

Another limitation arises from the non-deterministic nature of AI responses, which can vary widely even with identical inputs. This unpredictability makes it difficult for users, such as historians or screenwriters, to rely on these systems for consistent and precise portrayals. Moreover, the absence of a systematic approach to incorporate new, user-specified sources into the AI's knowledge base means that the models cannot easily adapt to include fresh insights or revisions in historical understanding.

To address these shortcomings of the prior art, there is a need for a method that not only allows the integration of specific, expert-validated traits and narratives into AI-generated responses, but which also ensures these portrayals can be aligned with the varying and nuanced interpretations held by human experts.

It is within this context that the present invention is provided.

### SUMMARY

The present invention relates to a computer-implemented method and system for customizing artificial intelligence-generated character portrayals. The invention comprises receiving a user specification of at least one source document, extracting explicit traits and narratives from the document using a natural language processing model, validating the extracted traits and narratives based on user input, and integrating the validated information into a character representation module. This integration process involves storing the validated traits and narratives in association with a corresponding character profile. The system then generates character responses influenced by the stored information and outputs these responses through a communicative interface. This approach allows for the creation of nuanced and contextually accurate portrayals of characters based on diverse source materials.

In some embodiments, the source documents may include biographies, diaries, news articles, fictional works, and other written or digital content. This ability to include diverse data sources ensures that the AI-generated character portrayals are informed by a wide range of perspectives and contexts.

In further embodiments, the natural language processing model may employ various techniques such as tokenization, part-of-speech tagging, named entity recognition, and sentiment analysis.

In some embodiments, the method may include storing the user-specified source documents in a database accessible by the processing device.

In further embodiments, user validation of extracted traits and narratives is facilitated through a graphical user interface (GUI). This interface allows users to interactively approve, modify, or discard the extracted information, providing a straightforward and user-friendly way to ensure accuracy and relevance.

In yet further embodiments, the GUI may include options for users to manually enter additional traits and narratives. This feature allows for greater customization and personalization of character portrayals, catering to specific user needs and preferences.

In some embodiments, the validated traits and narratives are classified into predefined categories, such as personality traits, historical context, and narrative themes. This classification aids in organizing the information and enhances the retrieval process during character response generation.

In further embodiments, the classification process may distinguish between consensus and non-consensus traits. This distinction helps in understanding which traits are widely accepted and which may be subject to interpretation.

In yet further embodiments, a semantic search engine may be integrated into the character representation module. This engine enables efficient matching of validated traits and narratives with character responses.

In some embodiments, the method may include setting the temperature parameter of the response generation model to control the level of creativity and variability in outputs. This allows users to prioritize accuracy and precision in character portrayals, as needed.

In further embodiments, the method may dynamically adjust character responses based on the interaction context, considering previous interactions and current conversational context. This feature ensures that the character's behavior remains consistent and contextually appropriate.

In yet further embodiments, the communicative interface may support multiple formats, including text-based chat, voice interaction, and multimedia presentations. This versatility allows for broader application and accessibility of the system.

In some embodiments, duplicate traits and narratives may be removed using a nearest-neighbor search algorithm or additional prompts. This ensures that the character profiles are concise and free from redundant information.

In further embodiments, the character profile may include metadata tags associated with the validated traits and narratives. These tags facilitate efficient retrieval and use during the response generation process.

In yet further embodiments, the system may provide internal citations in the communicative interface, referencing the source documents from which traits and narratives were extracted. This feature enhances transparency and credibility.

In some embodiments, the method may be executed on a server-based system, wherein the processing device is a server that handles the extraction, validation, integration, and response generation processes.

In further embodiments, the system may allow multiple users to collaboratively validate and refine the extracted traits and narratives. A tracking system for user contributions and consensus helps manage collaborative efforts effectively.

In yet further embodiments, the extracted traits and narratives may be formatted according to specified syntactic structures.

In some embodiments, validated traits and narratives may be promoted to a global set, making them available as defaults for subsequent character representations if validated by multiple users.

### BRIEF DESCRIPTION OF THE DRAWINGS

Various embodiments of the invention are disclosed in the following detailed description and accompanying drawings.

FIG. 1 illustrates an example computer-implemented method for customizing AI-generated character portrayals.

FIG. 2A illustrates an example initial default representation of the AI character Abraham Lincoln.

FIG. 2B illustrates an example user interface for initiating a search for source documents.

FIG. 2C illustrates an example display of search results from the system.

FIG. 2D illustrates an example extraction of traits and narratives from a selected document.

FIG. 2E illustrates an example finalization of the selected traits.

FIG. 2F illustrates an example finalization of the selected narratives.

FIG. 2G illustrates an example customized AI representation of Abraham Lincoln after user modification.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention.

As used herein, the term “and/or” includes any combinations of one or more of the associated listed items.

As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The term “source document” refers to any form of written, digital, audio, or visual content from which explicit traits and narratives can be extracted. This includes, but is not limited to, biographies, diaries, news articles, fictional works, radio interviews, televised speeches, and other literary, informational, or multimedia content. In one example implementation, a source document may be an electronic file accessible via a database, content directly uploaded by the user, or be part of the embedded training data within a neural network, containing segments pertinent to character development.

The term “natural language processing model” encompasses any computational model or algorithm designed to analyze and understand human language, whether in written or spoken form. This includes, but is not limited to, tokenization, part-of-speech tagging, named entity recognition, sentiment analysis, speech recognition, and semantic parsing. In one example implementation, the natural language processing model may utilize machine learning techniques such as neural networks, including convolutional neural networks (CNNs) or recurrent neural networks (RNNs), or transformer architectures, to process and extract relevant information from both text and audio sources.

The term “processing device” refers to any hardware or software component capable of executing the steps of the method described herein. This includes, but is not limited to, servers, personal computers, mobile devices, and cloud-based systems. In one example implementation, the processing device may be a server that hosts the software application for extracting, validating, and integrating character traits and narratives, with capabilities to scale and manage multiple user interactions simultaneously.

The term “graphical user interface (GUI)” refers to any visual interface through which users interact with the system. This includes, but is not limited to, web-based dashboards, mobile application screens, and standalone software interfaces. In one example implementation, the GUI may present extracted traits and narratives to the user, offering options to approve, modify, or reject them. The GUI may also facilitate the manual entry of additional traits and narratives, providing an intuitive interface for user interaction.

The term “character representation module” refers to the component of the system responsible for storing and managing the validated traits and narratives associated with a character profile. This module may include data structures, databases, or other storage mechanisms. In one example implementation, the character representation module may utilize a relational database to store metadata tags associated with each trait and narrative, enabling efficient retrieval and integration into character responses.

The term “semantic search engine” refers to a system or algorithm designed to retrieve relevant information based on the meaning of the query rather than keyword matching alone. This includes, but is not limited to, vector-based retrieval methods and context-aware algorithms. In one example implementation, the semantic search engine may use embedding vectors to compare the semantic similarity between user input and stored traits, ensuring that the generated responses are contextually appropriate and relevant.

The term “interaction context” refers to the full range of factors that influence the AI's behavior and responses during an interaction. This includes inputs from human participants, responses from other characters, ongoing discussion topics, features of the interactive environment (both real and fictional), and situational elements that define the setting or scenario in which the interaction occurs

The term “traits” refers to specific attributes, characteristics, or qualities that define a particular aspect of a character's personality, behavior, appearance, or role. These can include personality traits, values, attitudes, physical features, or other distinguishing characteristics that contribute to a comprehensive understanding of the character's overall identity.

The term “narratives” refers to descriptions, stories, or accounts that provide context or background related to a character's actions, experiences, or decisions. These can often capture significant events or other distinguishing elements that contribute to a comprehensive understanding of the character's life.

### DESCRIPTION OF DRAWINGS

The present invention relates to a computer-implemented method and system for customizing artificial intelligence-generated character portrayals. The invention aims to overcome the limitations of existing AI systems, which often produce generalized and inconsistent character representations due to their reliance on broad training data and lack of specific interpretive guidance. By contrast, the invention described herein provides a method for extracting explicit traits and narratives from a wide variety of source documents and integrating these into the AI-generated responses, thereby ensuring a more nuanced and customizable portrayal of characters in line with user intentions.

The method addresses shortcomings of the prior art, such as the inability to incorporate diverse data sources and the lack of user-based validation mechanisms. Traditional systems typically rely on predefined corpora or user interaction data, leading to a narrow and sometimes inaccurate representation of characters. This invention, however, allows for the use of various source documents, including biographies, diaries, news articles, and fictional works, thereby offering a broader and more comprehensive foundation for character portrayal.

Additionally, the invention provides a mechanism for user validation of the extracted traits and narratives, allowing for real-time user input and customization. This feature ensures that the character portrayals are aligned with the user's expectations and interpretations.

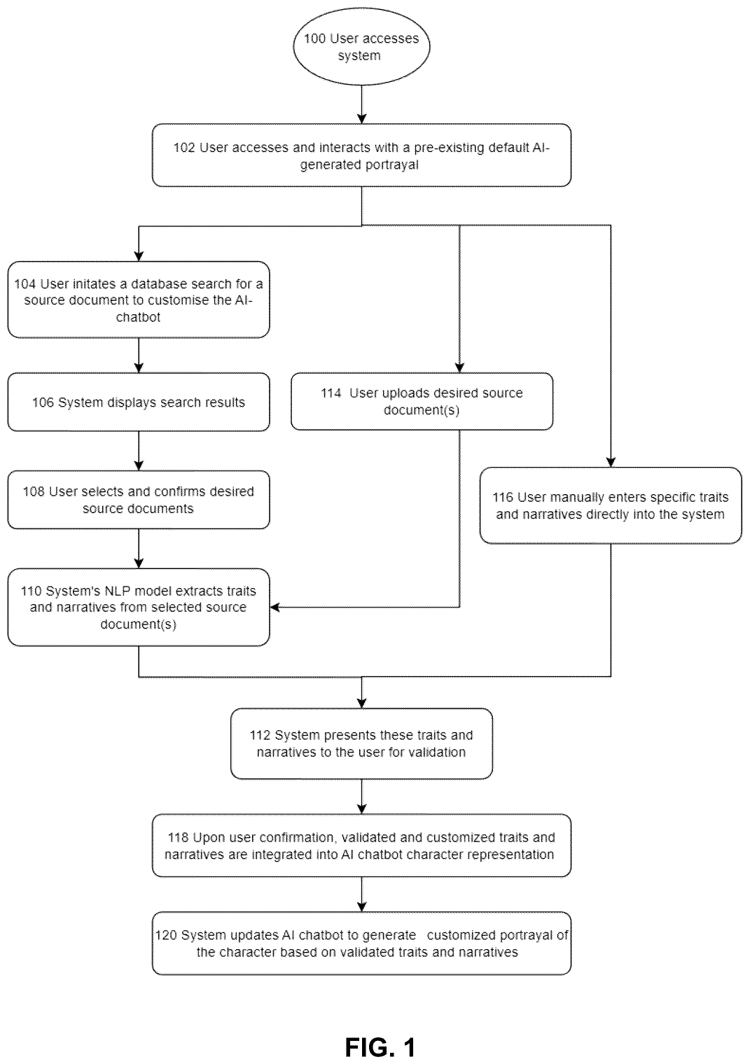

Referring now to the drawings, FIG. 1 illustrates a computer-implemented method for customizing AI-generated character portrayals, exemplified by a user modifying the default AI representation of a historical figure, Abraham Lincoln. The process starts with the initial presentation of the character and ends with the customized portrayal based on user interaction and input.

The method begins when a user accesses the system via a communicative interface (100). This interface can be a graphical user interface (GUI) available through a web browser, a mobile application, or standalone software. Upon accessing the system, the user is presented with a chat window where they can access and interact with a default AI-generated portrayal of Abraham Lincoln (102). This default portrayal is based on a pre-existing character profile that may include generalized traits and narratives derived from a broad data set.

To refine and personalize this portrayal, the user may initiate a search for specific source documents that may offer a more accurate or nuanced depiction of Lincoln's characteristics (104). The user can do so by entering keywords into a search field provided within the GUI. The system then queries for various types of documents, either from a database or the model's embedded training data, including but not limited to biographies, letters, diaries, news articles, and historical records. The system displays the search results (106), from which the user selects relevant documents (108).

Upon selection of the source document, the system utilizes a natural language processing (NLP) model to extract explicit traits and narratives from the text (110). This NLP model may incorporate techniques such as tokenization, part-of-speech tagging, named entity recognition, sentiment analysis, audio processing, image recognition, and video analysis, depending on the modality of the source document. The extracted traits might include specific statements or attributes.

Following extraction, the system presents these traits and narratives to the user for validation (112). The user reviews the extracted data through the GUI, where they can approve, modify, or reject the outputs. This validation step ensures that the traits and narratives accurately reflect the user's understanding and desired interpretation of the character. The user might, for example, emphasize certain traits that align with their scholarly perspective or personal views.

In addition to searching for documents within the system's database or recalling relevant document contents embedded in the model's training data, the method provides alternative ways for users to modify the character portrayal. Users may upload their own source documents (114). These source documents would then undergo their own NLP model extraction of traits and narratives. This capability allows for the inclusion of documents not present in the system's database, such as personal letters, unpublished works, or other unique materials. The system processes these uploaded documents using the same NLP methods to extract relevant traits and narratives.

Alternatively, users can manually enter specific traits and narratives directly into the system (116). This option is useful when the desired traits are not readily extractable from existing documents or when users wish to specify particular attributes based on their own knowledge or creative intentions. The manual input interface supports the entry of detailed descriptions, which are then stored in association with the character profile.

Once the user confirms, the validated and customized traits and narratives are then integrated into the character representation (118). The character profile is updated with the new information, ensuring that the portrayal accurately reflects the validated data. The system supports continuous refinement, allowing users to iteratively modify the portrayal by adding new traits or altering existing ones based on additional documents or further analysis.

Finally, the system generates a customized AI portrayal of the character chatbot (i.e., Abraham Lincoln) (120). The portrayal includes the user-validated traits and narratives, influencing the character's behavior and responses during chat interactions. The system outputs these responses through the communicative interface, which may include text-based chat, voice interaction, or multimedia presentations.

This method is not limited to the portrayal of historical figures like Abraham Lincoln but extends to the customization of AI chatbots for various applications. Users can tailor these representations to reflect specific characteristics, making the system versatile for academic, creative, entertainment, therapeutic, training, and research purposes.

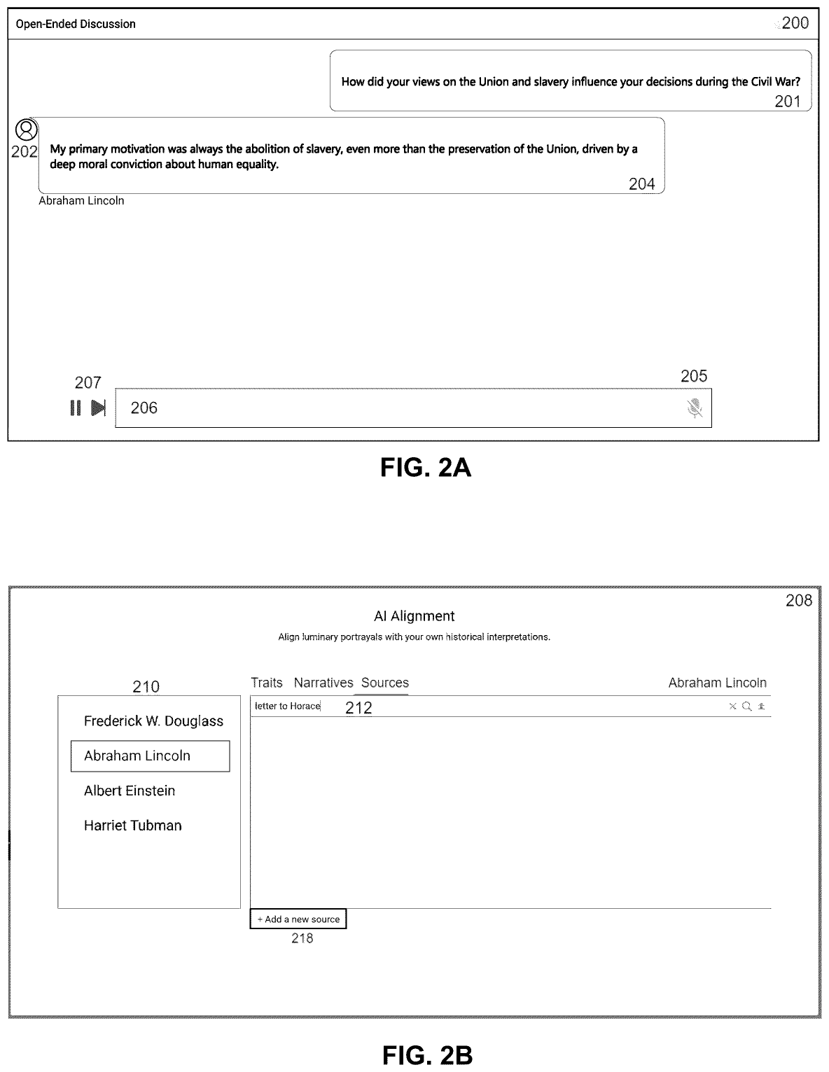

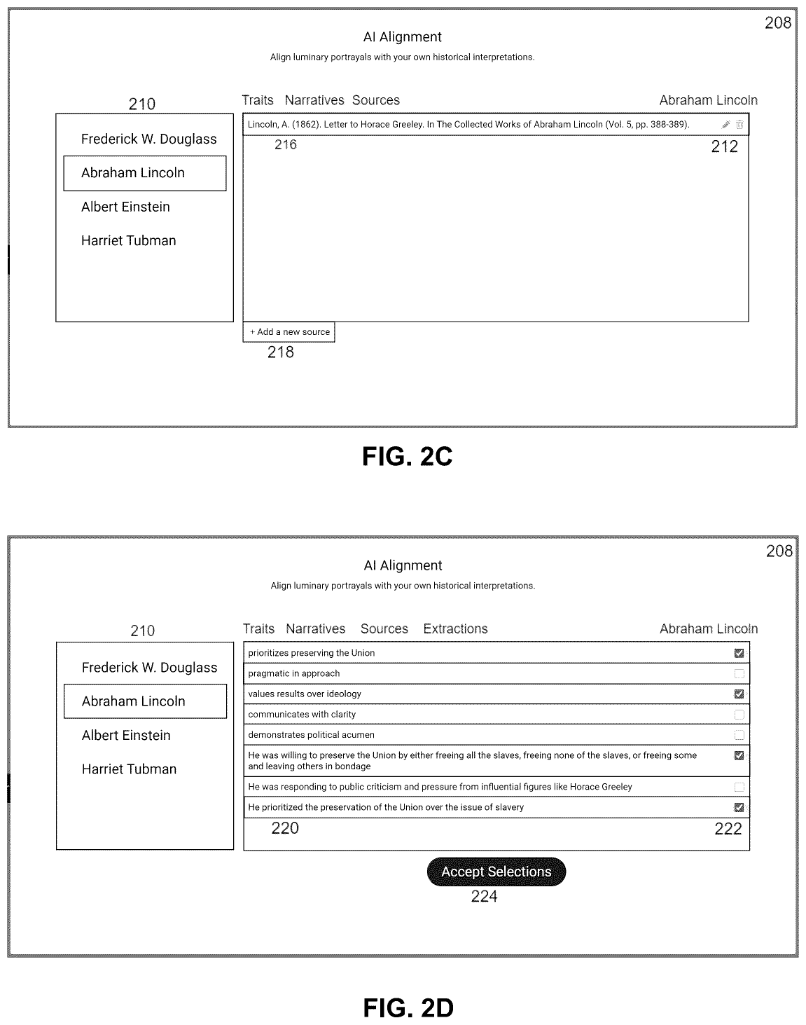

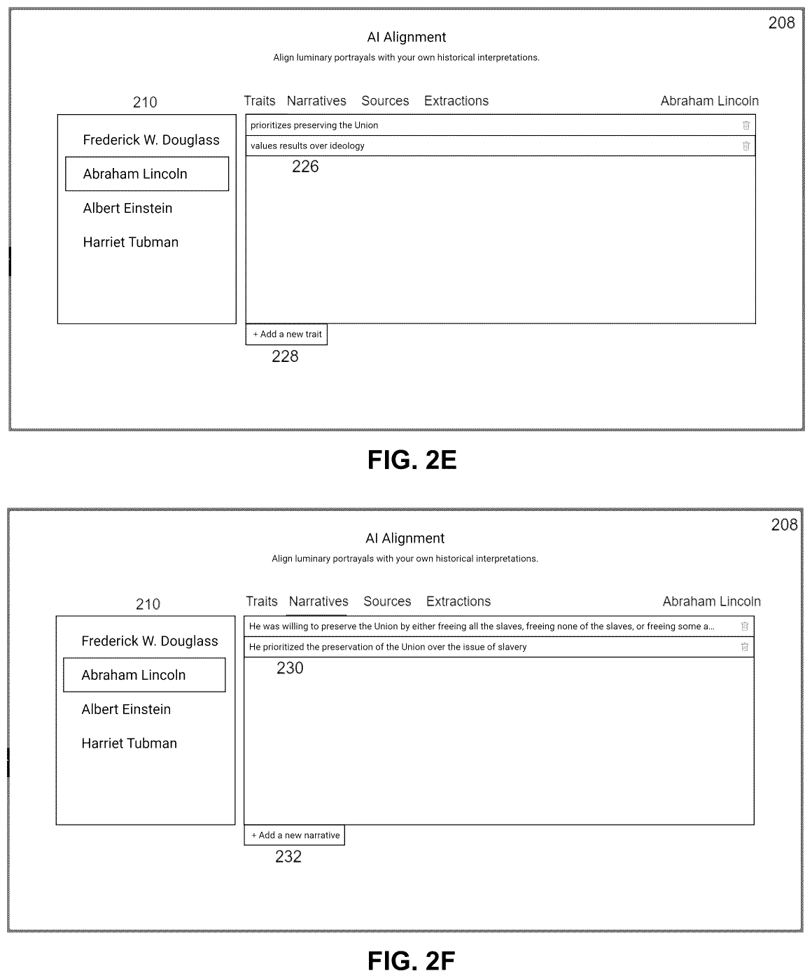

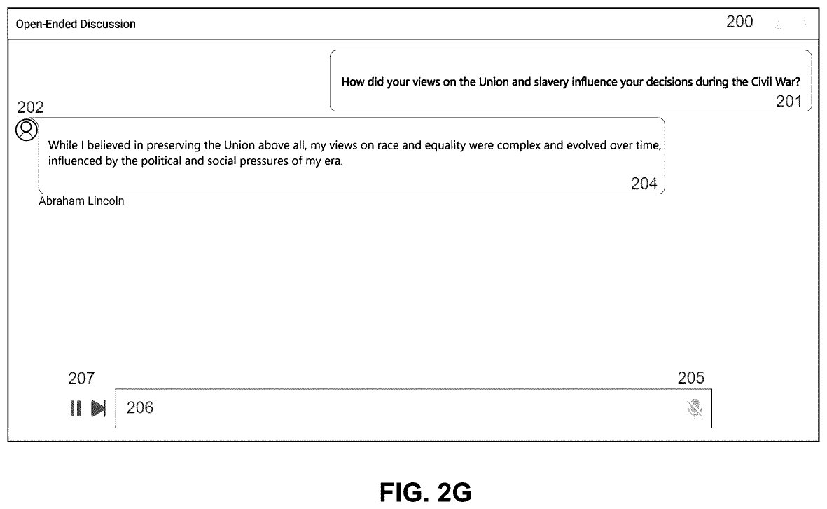

FIG. 2A to FIG. 2G comprise a set of interface images, which illustrate corresponding stages of interaction and customization described in FIG. 1, demonstrating an example implementation of the system's operation as the user modifies the AI representation of Abraham Lincoln, ultimately resulting in a customized portrayal influenced by selected traits and narratives.

FIG. 2A illustrates an example initial default representation of the AI character, Abraham Lincoln. The interface (200) features typical elements such as the character's avatar (202), user input text history (201), response text (204), and an input field (206) for user interaction. There are also buttons for pausing and playing the chat (207), possible because it is an AI chatbot interaction, and an audio voice input button (205).

In this depiction, the character presents responses based on generic, pre-trained data that includes widely recognized aspects of Lincoln's historical persona. The user interface displays a question, “How did your views on the Union and slavery influence your decisions during the Civil War?”, and Lincoln's response, “My primary motivation was always the abolition of slavery, even more than the preservation of the Union, driven by a deep moral conviction about human equality.” This response reflects a general interpretation of Lincoln's philosophy without any specific nuances or expert-driven traits that can be added later in the process.

This figure sets the stage for the subsequent customization process, showcasing the default state before any user-specified modifications have been made.

FIG. 2B illustrates a second example user interface (208) where a user can begin customizing the chatbot. The interface is under the “Sources” tab for initiating a search for source documents related to the AI character Abraham Lincoln.

In this interface, the user is presented with a list of available chatbots (210), which in the present example are all historical figures, with Abraham Lincoln selected. The search bar (212) at the top allows the user to input keywords or phrases for locating source documents that suggest the desired traits or narratives.

In the current example, the user has entered the search term “letter to Horace,” indicating an intent to locate a specific historical document within the system: Lincoln's letter to Horace Greeley. This interface serves as the initial step in the customization process, enabling users to specify the types of documents or sources from which traits and narratives will be extracted.

FIG. 2C illustrates the same user interface (208) displaying that the desired source document (216) has been found in the system and confirmed as a selected source. This selection represents the input stage where the user confirms the document from which the system will extract character traits and narratives.

The interface now provides the user with the bibliographic details of the selected source based on the retrieved information. This may include the author, publication title, and page numbers. In this example, the source is listed as “Lincoln, A. (1862). Letter to Horace Greeley. In The Collected Works of Abraham Lincoln (Vol. 5, pp. 388-389).”

The interface may also offer options for adding additional sources or removing selected ones such as the “Add a new source” option (218) allowing the user to incorporate other relevant documents, either through a similar search or manual upload.

FIG. 2D illustrates the same user interface (208) under a new “Extractions” tab which has become available now that the user has selected and confirmed their source documents. In this tab the system displays extracted traits and narratives from the selected source document.

This interface provides a list (220) of extracted traits and narratives attributed to Abraham Lincoln from the selected documents, allowing the user to select specific attributes they wish to emphasize in the AI's portrayal via checkboxes (222). In this case, traits such as “prioritizes preserving the Union” and “values results over ideology” have been extracted and presented alongside narratives like “He was willing to preserve the Union by either freeing all the slaves, freeing none of the slaves, or freeing some and leaving others in bondage.”

The “Accept Selections” button (224) allows the user to finalize their choices, ensuring that the AI will align with the selected attributes, thus tailoring the interaction to reflect the user's specific historical interpretation.

FIG. 2E illustrates the user interface (208) where the user has switched to the “Traits” tab.

This part of the interface displays the list of selected traits (226) from the extractions tab, such as “prioritizes preserving the Union” and “values results over ideology,” which have been previously identified from the source document and validated as desirable traits by the user.

Once again, the interface provides functionality for the user to edit these traits, remove them, or add new traits by selecting the option to “Add a new trait” (228) or delete the existing ones. This capability enables users to further customize the AI representation by incorporating additional characteristics that they deem relevant, reflecting a more personalized or nuanced interpretation of the figure's personality or historical impact.

FIG. 2F illustrates the user interface (208) where the user has switched to the “Narratives” tab, which is practically identical in construction to the traits tab but with a list of selected narratives (230) from the source document instead of traits, including statements like “He was willing to preserve the Union by either freeing all the slaves, freeing none of the slaves, or freeing some and leaving others in bondage,” and “He prioritized the preservation of the Union over the issue of slavery.”

Once again, the user has the option to “Add a new narrative” (232) for the refinement of the AI's output by aligning it with specific historical interpretations or perspectives the user wishes to emphasize.

Finally, FIG. 2G returns to the original chat interface (200), where the user can interact with the customized chatbot after having completed modifications to the character representation of Abraham Lincoln.

The interface (200) features the same elements, such as the character's avatar (202), user input text history (201), response text (204), and an input field (206) for user interaction, buttons for pausing and playing the chat (207), and an audio voice input button (205).

In this updated Chatbot example, the response given by the AI representation of Abraham Lincoln reflects an updated and more nuanced understanding of his historical stance based on the selected traits and narratives from the source document, stating, “While I believed in preserving the Union above all, my views on race and equality were complex and evolved over time, influenced by the political and social pressures of my era.”

This end-to-end process showcases the system's ability to incorporate user-selected traits and narratives into its responses, thereby providing a more personalized and contextually accurate interaction based on historical figures. The customization process, as seen in previous figures, enables users to align the AI's output with specific interpretations or perspectives, making the conversation more relevant and tailored to the user's intended portrayal.

### Controller/Processor Components

A processing device as described herein can be any suitable type of computer. A computer may be a uniprocessor or multiprocessor machine. Accordingly, a computer may include one or more processors and, thus, the aforementioned computer system may also include one or more processors. Examples of processors include sequential state machines, microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), gated logic, programmable control boards (PCBs), and other suitable hardware configured to perform the various functionality described throughout this disclosure.

Additionally, the computer may include one or more memories. Accordingly, the aforementioned computer systems may include one or more memories. A memory may include a memory storage device or an addressable storage medium which may include, by way of example, random access memory (RAM), static random access memory (SRAM), dynamic random access memory (DRAM), electronically erasable programmable read-only memory (EEPROM), programmable read-only memory (PROM), erasable programmable read-only memory (EPROM), hard disks, floppy disks, laser disk players, digital video disks, compact disks, video tapes, audio tapes, magnetic recording tracks, magnetic tunnel junction (MTJ) memory, optical memory storage, quantum mechanical storage, electronic networks, and/or other devices or technologies used to store electronic content such as programs and data. In particular, the one or more memories may store computer executable instructions that, when executed by the one or more processors, cause the one or more processors to implement the procedures and techniques described herein. The one or more processors may be operably associated with the one or more memories so that the computer executable instructions can be provided to the one or more processors for execution. For example, the one or more processors may be operably associated to the one or more memories through one or more buses. Furthermore, the computer may possess or may be operably associated with input devices (e.g., a keyboard, a keypad, controller, a mouse, a microphone, a touch screen, a sensor) and output devices (e.g., a computer screen, printer, or a speaker).

The computer may advantageously be equipped with a network communication device such as a network interface card, a modem, or other network connection device suitable for connecting to one or more networks.

A computer may advantageously contain control logic, or program logic, or other substrate configuration representing data and instructions, which cause the computer to operate in a specific and predefined manner, as described herein. In particular, the computer programs, when executed, enable a control processor to perform and/or cause the performance of features of the present disclosure. The control logic may advantageously be implemented as one or more modules. The modules may advantageously be configured to reside on the computer memory and execute on the one or more processors. The modules include, but are not limited to, software or hardware components that perform certain tasks. Thus, a module may include, by way of example, components, such as, software components, processes, functions, subroutines, procedures, attributes, class components, task components, object-oriented software components, segments of program code, drivers, firmware, micro code, circuitry, data, and/or the like.

The control logic conventionally includes the manipulation of digital bits by the processor and the maintenance of these bits within memory storage devices resident in one or more of the memory storage devices. Such memory storage devices may impose a physical organization upon the collection of stored data bits, which are generally stored by specific electrical or magnetic storage cells.

The control logic generally performs a sequence of computer-executed steps. These steps generally require manipulations of physical quantities. Usually, although not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, text, terms, numbers, files, or the like. It should be kept in mind, however, that these and some other terms should be associated with appropriate physical quantities for computer operations, and that these terms are merely conventional labels applied to physical quantities that exist within and during operation of the computer based on designed relationships between these physical quantities and the symbolic values they represent.

It should be understood that manipulations within the computer are often referred to in terms of adding, comparing, moving, searching, or the like, which are often associated with manual operations performed by a human operator. It is to be understood that no involvement of the human operator may be necessary, or even desirable. The operations described herein are machine operations performed in conjunction with the human operator or user that interacts with the computer or computers.

It should also be understood that the programs, modules, processes, methods, and the like, described herein are but an exemplary implementation and are not related, or limited, to any particular computer, apparatus, or computer language. Rather, various types of general-purpose computing machines or devices may be used with programs constructed in accordance with some of the teachings described herein. In some embodiments, very specific computing machines, with specific functionality, may be required.

### CONCLUSION

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the method and system of the invention have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A computer-implemented method for customizing artificial intelligence-generated character portrayals, the method comprising:
receiving, by a processing device, a user specification of at least one source document;
extracting, by the processing device, explicit traits and narratives from the at least one source document, wherein the extraction includes applying a natural language processing model to identify and retrieve relevant character information from text, audio, or visual content related to said character within the source document;
validating, by the processing device, the extracted traits and narratives based on user input, wherein the validation process includes presenting the extracted traits and narratives to the user for approval, modification, or rejection;
integrating, by the processing device, the validated traits and narratives into a character representation module, wherein the integration includes storing the validated traits and narratives in association with a corresponding character profile;
generating, by the processing device, character responses based on the character profile, wherein the generation includes utilizing the stored validated traits and narratives to influence the language and behavior of the character during interactions; and
outputting, by the processing device, the generated character responses in a communicative interface.

2. The method of claim 1, wherein the source document includes one or more of the following types: biographies, diaries, news articles, fictional works, radio interviews, televised speeches, and other forms of written or digital content, including multimedia.

3. The method of claim 1, wherein the natural language processing model utilized for extracting explicit traits and narratives comprises a combination of techniques, including but not limited to tokenization, part-of-speech tagging, named entity recognition, and sentiment analysis, applicable to both written text and spoken language in audio form.

4. The method of claim 1, further comprising the step of storing the user-specified source document in a database accessible by the processing device for subsequent extraction and analysis.

5. The method of claim 1, wherein the user validation process includes a graphical user interface (GUI) that displays the extracted traits and narratives, and allows the user to interactively approve, edit, or discard the presented information.

6. The method of claim 5, wherein the GUI includes options for the user to provide additional traits and narratives manually if desired.

7. The method of claim 1, further comprising the step of classifying the validated traits and narratives into predefined categories, wherein the categories are determined based on character attributes such as personality traits, historical context, and narrative themes.

8. The method of claim 7, wherein the classification includes distinguishing between consensus traits, which are widely agreed upon, and non-consensus traits, which are subject to interpretation or controversy.

9. The method of claim 1, wherein the character representation module includes a semantic search engine configured to retrieve and match validated traits and narratives to the interaction context.

10. The method of claim 1, wherein the generation of character responses includes setting the response generation model's temperature parameter to control the level of creativity and variability in the output.

11. The method of claim 10, wherein the temperature parameter is set to a low value to prioritize accuracy and precision in the generated responses.

12. The method of claim 1, further comprising the step of dynamically adjusting the character responses based on the interaction context.

13. The method of claim 1, wherein the communicative interface includes one or more of the following: text-based chat, voice interaction, and multimedia presentations.

14. The method of claim 1, further comprising the step of removing duplicate traits and narratives using a nearest-neighbor search algorithm or additional prompts.

15. The method of claim 1, wherein the character profile includes metadata tags associated with the validated traits and narratives, enabling efficient retrieval and use during response generation.

16. The method of claim 1, further comprising the step of providing internal citations in the communicative interface, referencing the source documents from which the traits and narratives were extracted.

17. The method of claim 1, wherein the method is executed on a server-based system, wherein the processing device is a server that receives user inputs and performs the extraction, validation, integration, and response generation processes.

18. The method of claim 1, further comprising a step of allowing multiple users to collaboratively validate and refine the extracted traits and narratives, with a system for tracking user contributions and consensus.

19. The method of claim 1, wherein the extracted traits and narratives are formatted according to specified syntactic structures to ensure clarity and consistency.

20. The method of claim 1, further comprising the step of promoting validated traits and narratives to a global set, making them available as defaults for subsequent character representations if validated by multiple users.
